(19) United States
(12) Patent Application Publication
(10) Pub. No.: US 2011/0300930 A1
(43) Pub. Date: Dec. 8, 2011

(54) Video game controller with an auxiliary display

(76) Inventor: Kent T. J. Hsu, Taipei (TW)

(21) Appl. No.: 12/795,671

(22) Filed: Jun. 8, 2010

(51) Int. Cl. A63F 13/00; A63F 13/06

(52) U.S. Cl. 463/30; 463/37

(57) ABSTRACT

A video game controller includes a control unit electrically connected to a video game console having a main display; and an auxiliary display electrically connected to the control unit and comprising a miniature display, a lens, a loud speaker, a microphone, and a power supply. The power supply is an interruptible power supply or battery power supply. The miniature display is an LCD.

### BACKGROUND OF THE INVENTION

1. Field of Invention

The invention relates to controllers for video game consoles and more particularly to such a video game controller having an auxiliary display for displaying data, status, etc. about a game being played.

2. Description of Related Art

Typically, a video game console is equipped with a game controller for playing. However, no auxiliary display in addition to a main display (which is for displaying a video game being played by an individual) is provided in the game controller. Thus, data, status, etc. about a game being played is not available in real time. This is not convenient. Thus, the need for improvement still exists.

### SUMMARY OF THE INVENTION

It is therefore one object of the invention to provide a video game controller comprising a control unit electrically connected to a video game console having a main display; and an auxiliary display electrically connected to the control unit and comprising a miniature display, a lens, a loud speaker, a microphone, and a power supply.

The above and other objects, features and advantages of the invention will become apparent from the following detailed description taken with the accompanying drawings.

### BRIEF DESCRIPTION OF THE DRAWINGS

FIG. 1 is a block diagram of a video game console incorporating a controller according to the invention;

FIG. 2 is a detailed block diagram of the auxiliary display;

FIG. 3 is a first preferred embodiment of the video game console incorporating a controller according to the invention;

FIG. 4 is a second preferred embodiment of the video game console incorporating a controller according to the invention;

FIG. 5 is a third preferred embodiment of the video game console incorporating a controller according to the invention;

FIG. 6 is a fourth preferred embodiment of the video game console incorporating a controller according to the invention;

FIG. 7 is a fifth preferred embodiment of the video game console incorporating a controller according to the invention;

FIG. 8 is an eighth preferred embodiment of the video game console incorporating a controller according to the invention;

FIG. 9 is a first configuration of the controller according to the invention when used independently; and

FIG. 10 is a second configuration of the controller according to the invention when used independently.

### DETAILED DESCRIPTION OF THE INVENTION

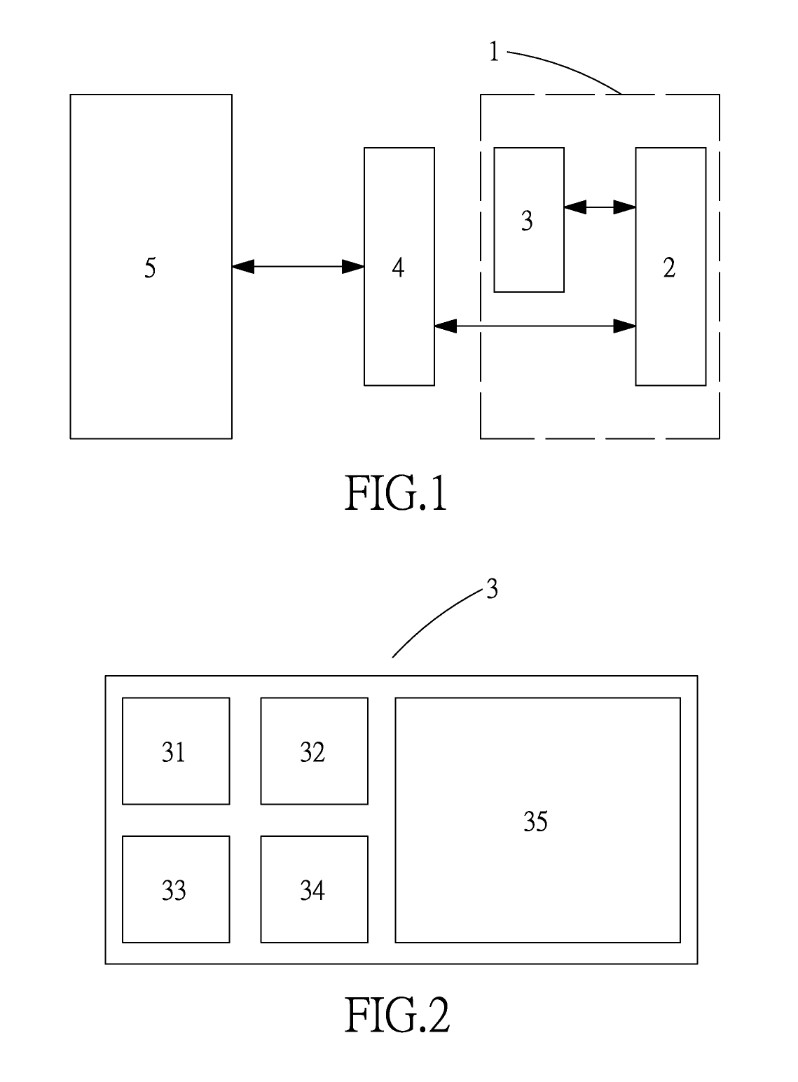

Referring to FIGS. 1 to 2, a video game console 4 incorporating a controller 1 in accordance with the invention is shown. A main display 5 is provided for displaying a video game being played by an individual by electrically connecting to the video game console 4. The controller 1 as the subject of the invention is discussed in detail below.

The controller 1 comprises a control unit 2 electrically connected to the video game console 4, and an auxiliary display 3 electrically connected to the control unit 2. The auxiliary display 3 comprises a miniature display (e.g., LCD (liquid crystal display) 35, a lens 31, a loud speaker 32, a microphone 33, and a power supply 34. Alternatively, the miniature display 35 is an OLED (organic light emitting diode) display or a touchscreen.

The provision of the miniature display 35 is for displaying data, status, etc. about a game being played in real time. The operations of the main display 5 and the miniature display 35 are independent. The power supply 34 can be a typical uninterruptable power supply or a battery power supply.

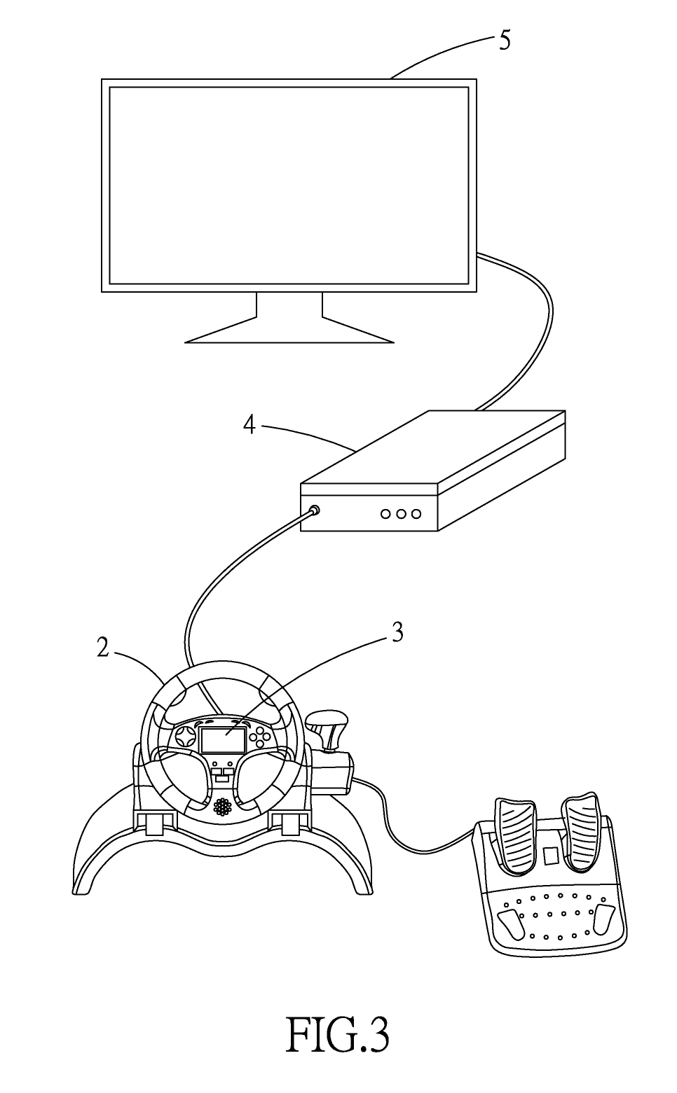

Referring to FIG. 3, a first preferred embodiment of the video game console 4 incorporating the controller 1 according to the invention is shown. The main display 5 is implemented as a monitor, the video game console 4 is implemented as a box, and the control unit 2 is implemented as an automobile's steering wheel and pedals all connected by wire.

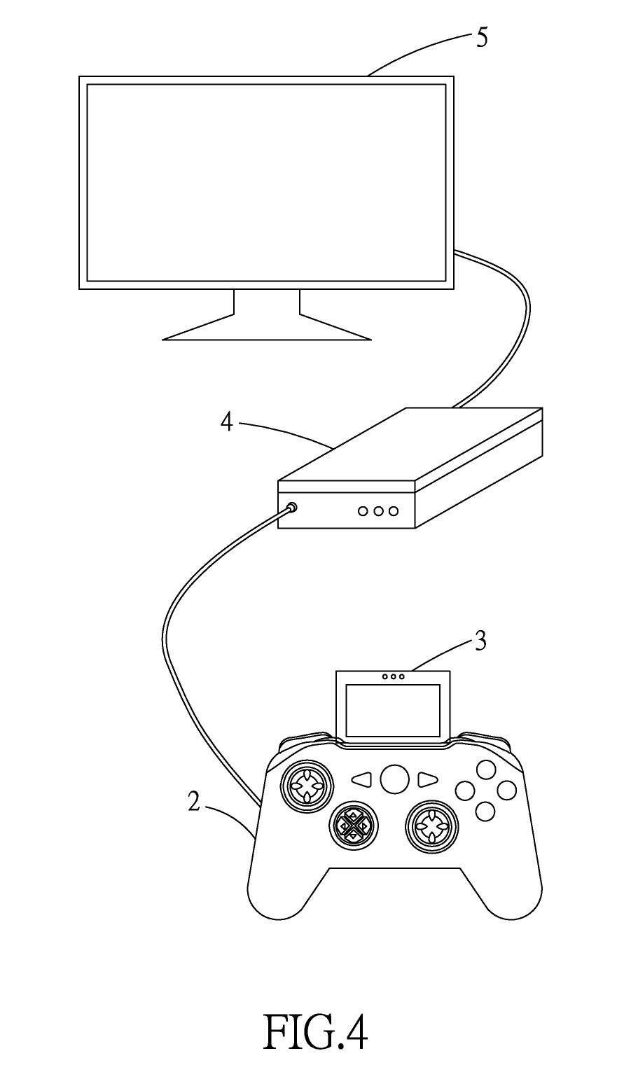

Referring to FIG. 4, a second preferred embodiment of the video game console 4 incorporating the controller 1 according to the invention is shown. The main display 5 is implemented as a monitor, the video game console 4 is implemented as a box, and the control unit 2 is implemented as a panel all connected by wire.

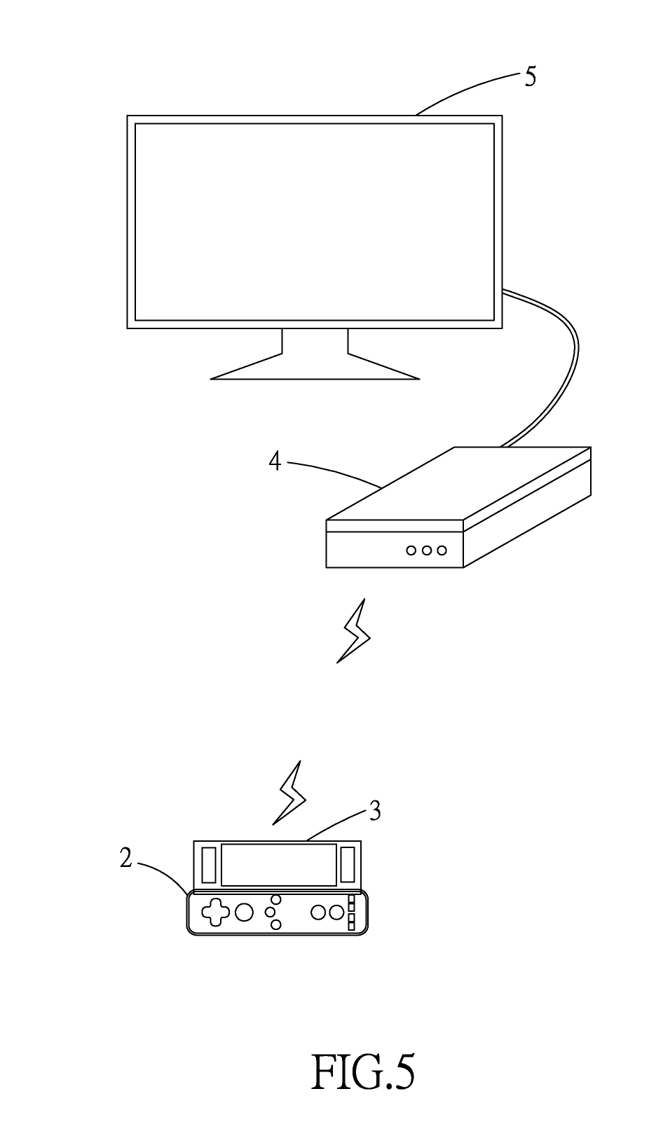

Referring to FIG. 5, a third preferred embodiment of the video game console 4 incorporating the controller 1 according to the invention is shown. The main display 5 is implemented as a monitor, the video game console 4 is implemented as a box, and the control unit 2 is implemented as a Wii Remote in which the main display 5 and the video game console 4 are connected together by wire and the Wii Remote is wirelessly connected to the video game console 4.

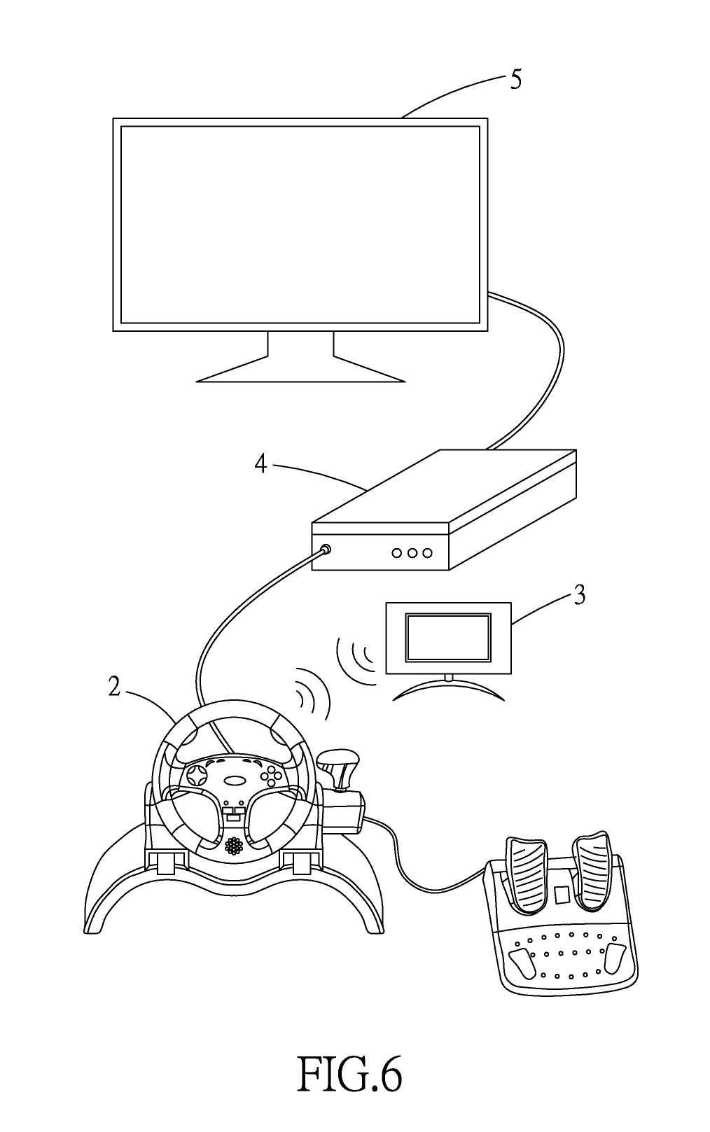

Referring to FIG. 6, a fourth preferred embodiment of the video game console 4 incorporating the controller 1 according to the invention is shown. The main display 5 is implemented as a monitor, the video game console 4 is implemented as a box, and the control unit 2 is implemented as an automobile's steering wheel and pedals all connected by wire. But the auxiliary display 3 is wirelessly connected to the control unit 2.

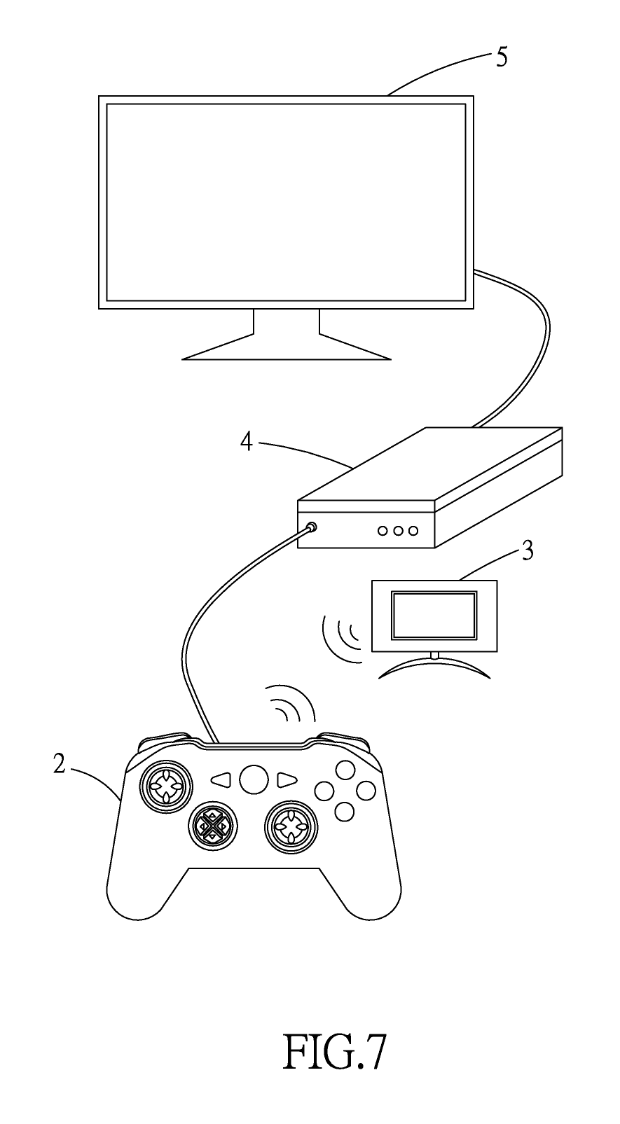

Referring to FIG. 7, a fifth preferred embodiment of the video game console 4 incorporating the controller 1 according to the invention is shown. The main display 5 is implemented as a monitor, the video game console 4 is implemented as a box, and the control unit 2 is implemented as a panel all connected by wire. But the auxiliary display 3 is wirelessly connected to the control unit 2.

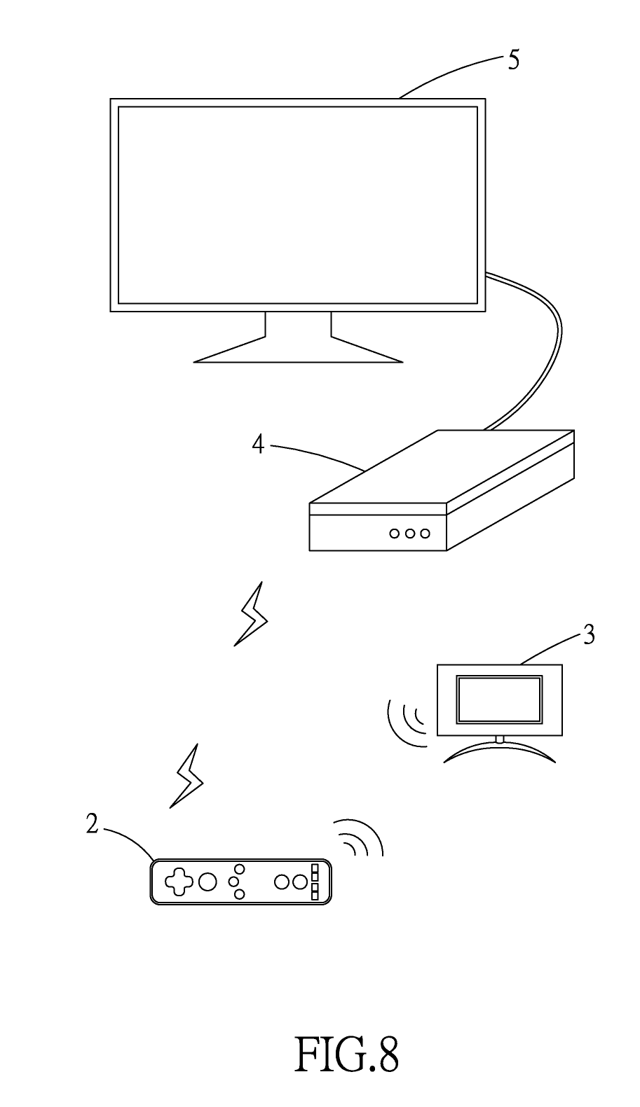

Referring to FIG. 8, a sixth preferred embodiment of the video game console 4 incorporating the controller 1 according to the invention is shown. The main display 5 is implemented as a monitor, the video game console 4 is implemented as a box, and the control unit 2 is implemented as a Wii Remote in which the main display 5 and the video game console 4 are connected together by wire, the Wii Remote is wirelessly connected to the video game console 4, and the auxiliary display is wirelessly connected to the control unit 2.

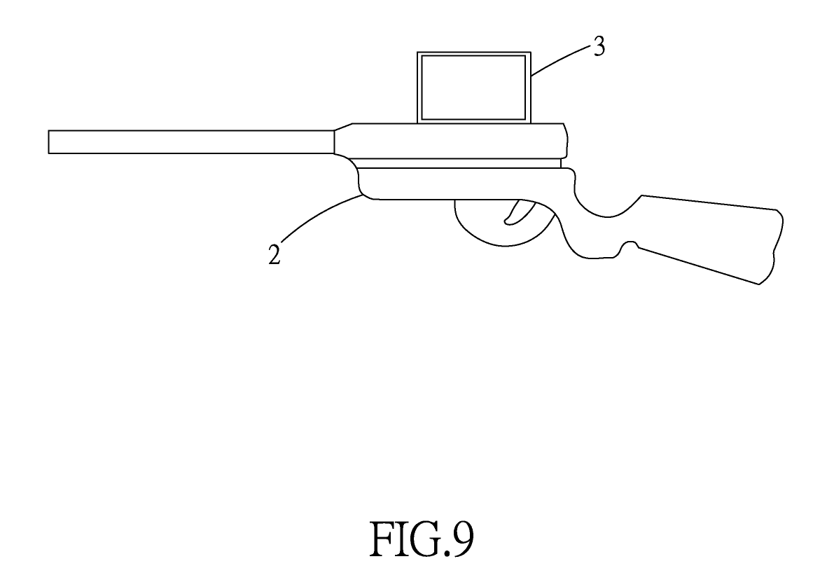

Referring to FIG. 9, a first configuration of the controller according to the invention is shown. The controller is used independently of the video game console and the main display. As shown, the controller comprises a rifle shaped control unit 2 and an auxiliary display 3 mounted thereon.

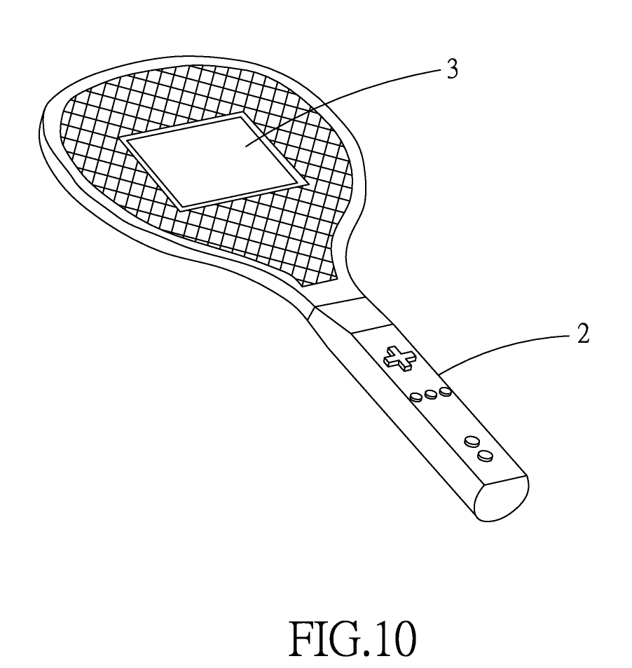

Referring to FIG. 10, a second configuration of the controller according to the invention is shown. The controller is used independently of the video game console and the main display. As shown, the controller comprises a handle shaped control unit 2 of a racquet and an auxiliary display 3 mounted on a network of cord thereof.

While the invention has been described in terms of preferred embodiments, those skilled in the art will recognize that the invention can be practiced with modifications within the spirit and scope of the appended claims.

What is claimed is:

1. A video game controller comprising:
a control unit electrically connected to a video game console having a main display; and
an auxiliary display electrically connected to the control unit and comprising a miniature display, a lens, a loud speaker, a microphone, and a power supply.

2. The video game controller of claim 1, wherein the power supply is an interruptible power supply.

3. The video game controller of claim 1, wherein the power supply is a battery power supply.

4. The video game controller of claim 1, wherein the miniature display is an LCD (liquid crystal display).

5. The video game controller of claim 1, wherein the miniature display is an OLED (organic light emitting diode) display.

6. The video game controller of claim 1, wherein the miniature display is a touchscreen.
